(19) United States
(12) Patent Application Publication
(10) Pub. No.: US 2018/0347698 A1
(43) Pub. Date: Dec. 6, 2018

(54) SEALING STRUCTURE FOR HOUSING JOIN OF FLUID MACHINE

(71) Applicant: SANDEN AUTOMOTIVE COMPONENTS CORPORATION, Isesaki-shi, Gunma (JP)

(72) Inventor: Kenji SAITOU, Isesaki-shi, Gunma (JP)

(21) Appl. No.: 15/761,710

(22) PCT Filed: Nov. 2, 2016
(86) PCT No.: PCT/JP2016/082657

§ 371 Date: Mar. 20, 2018

(30) Foreign Application Priority Data
Nov. 4, 2015 (JP) 2015-216768

(51) Int. Cl. F16J 15/02; F04C 29/00

(52) U.S. Cl. CPC F16J 15/022; F04C 29/00; F04C 2240/40; F04C 2240/30; F04C 2210/26

(57) ABSTRACT

To provide a sealing structure for a housing join of a fluid machine such as a compressor or expander, which can prevent a twist in an O ring and resultant reduction in sealing property. The sealing structure for a housing join of a fluid machine, which is used to seal a join between a first housing member 1 and a second housing member 2 that constitute a housing of the fluid machine, includes: a ring groove 14 formed in an end surface 11 of the first housing member 1, and an O ring 3 to be inserted into the ring groove 14. The ring groove 14 has an inverted trapezoid shape in cross section, and when the first housing member 1 and the second housing member 2 are joined together, the inserted O ring 3 is compressed between a bottom surface 14a and an end surface 21 of the second housing member 2 and the compressed O ring 3 comes into contact with the bottom surface 14a and both of a pair of side surfaces 14b, 14c extending upward from the bottom surface 14a at its opposite ends in a width direction.

### TECHNICAL FIELD

The present invention relates to a sealing structure for a housing join of a fluid machine, which is for sealing a join between first and second housing members that constitute a fluid machine such as a compressor and an expander.

### BACKGROUND ART

An electric compressor disclosed in Patent Document 1 has been known as an example of a fluid machine with this type of sealing structure. In the electric compressor of Patent Document 1, a housing includes a front casing for housing a compressor mechanism, a motor casing for housing an electric motor, and a frame, which are fastened together by means of bolts. A join between the front casing and the frame is sealed by an O ring inserted into a ring groove formed at the front casing, and a join between the motor casing and the frame is sealed by an O ring inserted into a ring groove formed at the motor casing.

### REFERENCE DOCUMENT LIST

### Patent Document

Patent Document 1: JP H9-42156 A

### SUMMARY OF THE INVENTION

### Problem to be Solved by the Invention

FIG. 6 is a schematic cross-sectional diagram showing a join between the front casing (or the motor casing) and the frame. As shown in FIG. 6, the ring groove is formed into a rectangular shape in cross section. The O ring is compressed between an end surface of the frame and the bottom surface of the ring groove when the front casing (or the motor casing) and the frame are joined. Then, when the electric compressor is operated, whereby an internal pressure of the housing becomes higher than an external pressure (e.g., atmospheric pressure) thereof, the O ring moves outwardly in the width direction inside the ring groove due to a pressure difference between the internal and external pressures of the housing (see arrow in FIG. 6) and comes into contact with an outer side surface of the ring groove in the width direction.

However, surface roughness of the end surface of the frame, surface roughness of the bottom surface of the ring groove and/or a compressed state of the O ring between the end surface of the frame and the bottom surface of the ring groove are not always uniform. There is a possibility that when the O ring moves in response to the pressure difference, the moving speed or distance of the O ring varies from place to place and the O ring is accordingly twisted. The twisted O ring shows low sealing property in some portions. Thus, it is required to prevent the O ring from twisting. This is a common issue for fluid machines including expanders as well as the compressors.

In light of the above, an object of the present invention is to provide a sealing structure for a housing join of a fluid machine, which is capable of preventing a twist in the O ring and resultant reduction in sealing property.

### Means for Solving the Problem

According to an aspect of the present invention, provided is a sealing structure for a housing join of a fluid machine, which is used to seal a join between first and second housing members constituting a housing of the fluid machine. The sealing structure for a housing join of a fluid machine comprises: a ring groove formed in an end surface of the first housing member; and an O ring to be inserted into the ring groove. The ring groove has an inverted trapezoid shape in cross section, of which a width of an opening edge is larger than a width of a bottom surface. Also, when the first and second housing members are joined together, the inserted O ring is compressed between the bottom surface and an end surface of the second housing member and the compressed O ring comes into contact with the bottom surface and both of a pair of side surfaces extending upward from the bottom surface at its opposite ends in a width direction.

### Effects of the Invention

In the sealing structure for the housing join of the fluid machine, the O ring inserted into the ring groove is compressed at least by joining the first and second housing members and also, the compressed O ring comes into contact with the bottom surface and pair of side surfaces of the ring groove. Hence, at the time of operating the compressor, the O ring does not move inside the ring groove in response to the pressure difference between the inside and outside of the housing and instead, just deforms. This prevents a twist in the O ring and resultant reduction in sealing property.

### BRIEF DESCRIPTION OF THE DRAWINGS

FIG. 1 is a cross-sectional diagram showing a main part of a sealing structure for a housing join (join between first and second housing members) of a compressor according to an embodiment of the present invention.

FIG. 2 shows the first housing member before joined to the second housing member.

FIG. 3 shows a state of the sealing structure for the housing join of the compressor at the time of operating the compressor.

FIG. 4 is a cross-sectional diagram showing a main part of a sealing structure for a housing join of a compressor according to another embodiment of the present invention.

FIG. 5 is a cross-sectional diagram showing a main part of a sealing structure for a housing join of a compressor according to still another embodiment of the present invention.

FIG. 6 is a cross-sectional diagram showing a main part of a sealing structure for a housing join of a compressor according to a conventional technique.

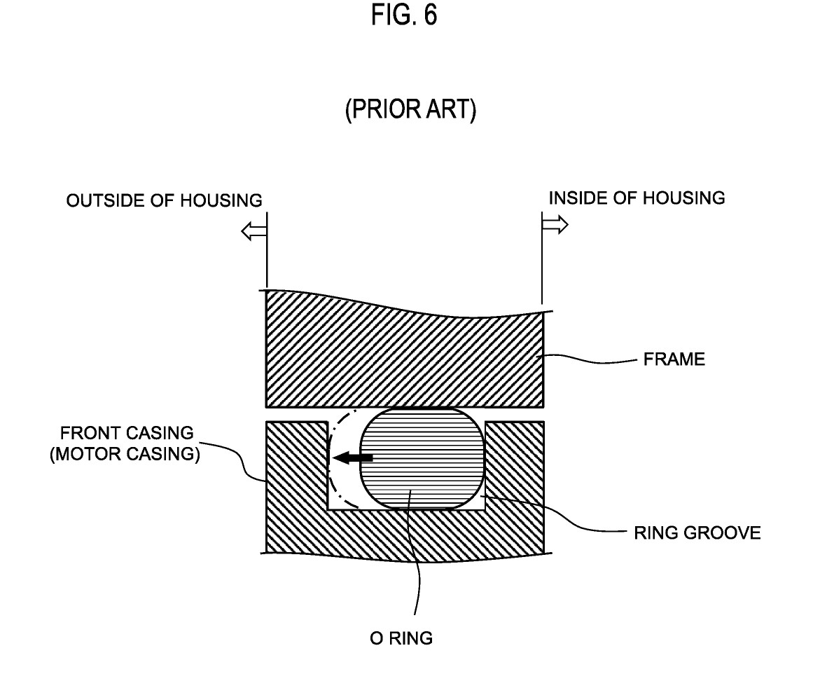

### MODE FOR CARRYING OUT THE INVENTION

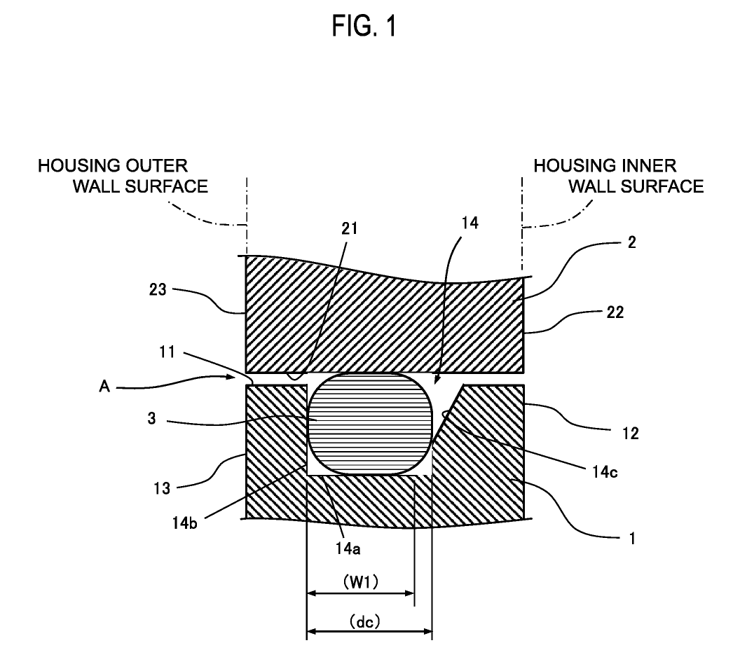

Embodiments of the present invention are described below with reference to the accompanying drawings. Note that the following description focuses on a compressor as a fluid machine, but the present invention is applicable to a wide variety of fluid machines including expanders as well as compressors. FIG. 1 is a cross-sectional diagram showing a main part of a sealing structure for a housing join of a compressor according to an embodiment of the present invention. The compressor is integrated into, for example, a refrigerant circuit of a vehicle air conditioner, and operated to compress a refrigerant at the time of operating the vehicle air conditioner. The housing of the compressor includes a first housing member 1 and a second housing member 2, both of which are formed into a cylindrical shape. Also, the first housing member 1 and the second housing member 2 are joined with their end surfaces (joining surfaces) 11, 21 being faced, by means of fastening members (not shown) such as bolts as shown in FIG. 1.

In FIG. 1, a right side surface 12 of the first housing member 1 and a right side surface 22 of the second housing member 2 constitute an inner wall surface of the housing, and a left side surface 13 of the first housing member 1 and a left side surface 23 of the second housing member 2 constitute an outer wall surface of the housing. Also, the first housing member 1 and the second housing member 2 can be any members constituting the housing of the compressor with no particular limitations. For example, if the compressor is an electric compressor, the first housing member 1 and the second housing member 2 can be any two different casings among a casing mainly for housing a compressor mechanism (e.g., scroll compressor mechanism), a casing mainly for housing an electric motor, and a frame provided between these casings.

A join A between the first housing member 1 and the second housing member 2 is sealed by an O ring 3 provided at the join. In this embodiment, the O ring 3 is inserted into the ring groove 14 formed annually in the end surface 11 of the first housing member 1. Needless to say, the ring groove may be formed in the end surface 21 of the second housing member 2 in place of the end surface 11 of the first housing member 1.

The ring groove 14 has an inverted trapezoid shape in cross section. That is, the ring groove 14 is formed wider at its opening edge than at its bottom surface. Preferably, the ring groove 14 is formed into an inverted right-angled trapezoid shape in cross section as shown in FIG. 1. More specifically, the ring groove 14 is defined by a flat bottom surface 14a, and a pair of side surfaces 14b, 14c extending upward at opposite ends of the bottom surface 14a in the width direction. Of the pair of side surfaces 14b, 14c, the one side surface 14b close to the outer wall surface of the housing is formed as a perpendicular surface at right angle (with a small margin for error) to the bottom surface 14a, and the other side surface 14c close to the inner wall surface of the housing is formed as an inclined surface that gradually increases a distance from the one side surface 14b in the direction from the bottom surface 14a to the opening edge.

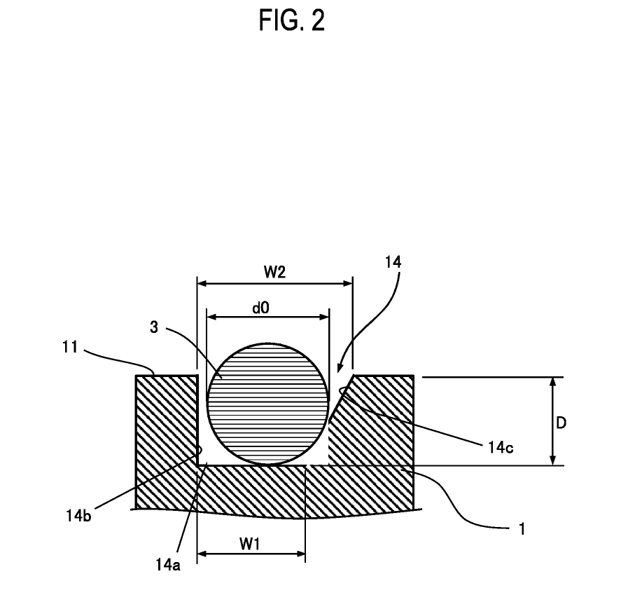

FIG. 2 shows the first housing member 1 before joined to the second housing member 2. As shown in FIG. 2, the ring groove 14 is formed such that the O ring 3 can be inserted thereinto in contact with the bottom surface 14a and the other side surface (inclined surface) 14c of the ring groove 14, with the O ring upper portion protruding from the opening edge of the ring groove 14. Thus, the O ring 3 inserted into the ring groove 14 is compressed between the bottom surface 14a of the ring groove 14 and the end surface 21 of the second housing member 2 by joining the first housing member 1 and the second housing member 2 together. Also, as shown in FIG. 1, the ring groove 14 is formed such that the O ring 3, compressed by joining the first housing member 1 and the second housing member 2 together, can come into contact with the one side surface 14b as well as the bottom surface 14a and the other side surface 14c.

Specifically, in this embodiment, the ring groove 14 has the following dimensions. That is, a depth D of the ring groove 14 is smaller than a wire diameter (wire diameter of the uncompressed ring) d0 of the O ring 3 (D<d0). Also, a width W1 of the bottom surface 14a of the ring groove 14 is smaller than a wire diameter dc of the compressed O ring 3 between the bottom surface 14a of the ring groove 14 and the end surface 21 of the second housing member 2, i.e., the diameter dc (>d0) of the O ring 3 in the width direction of the ring groove 14 (more specifically, in the width direction of the bottom surface 14a), which is increased by compression between the bottom surface 14a of the ring groove 14 and the end surface 21 of the second housing member 2 (W1<dc). Moreover, a width W2 of the opening edge of the ring groove 14 is larger than the wire diameter d0 of the O ring (W2>d0) and also larger than the width W1 of the bottom surface 14a of the ring groove 14 (W2>W1).

Next, described are operations of the above sealing structure for the housing join of the compressor.

First, the O ring 3 is inserted into the ring groove 14 formed in the end surface 11 of the first housing member 1 before the first housing member 1 and the second housing member 2 are joined together. The inserted O ring 3 comes into contact with the bottom surface 14a of the ring groove 14 and the other side surface (side surface close to the inner wall surface of the housing) 14c as described above and also, its upper portion protrudes from the opening edge of the ring groove 14 (see FIG. 2).

Next, the first housing member 1 and the second housing member 2 are joined together, whereby the upper portion of the O ring 3 protruding from the opening edge of the ring groove 14 is pressed by the end surface 21 of the second housing member 2. That is, the O ring 3 is compressed between the bottom surface 14a of the ring groove 14 and the end surface 21 of the second housing member 2. Then, the wire diameter of the O ring 3 is reduced in the direction of compression (vertical direction in the drawings) compared with the diameter (d0) of the uncompressed one, but is increased in the width direction (lateral direction in the drawings) of the ring groove 14 orthogonal to the direction of compression (d0⇒dc). As a result, the O ring 3 comes into contact with the one side surface (side surface close to the outer wall surface of the housing) 14b of the ring groove 14 as well as the bottom surface 14a and the other side surface 14c of the ring groove 14. Furthermore, the O ring 3 is in contact with the end surface 21 of the second housing member 2, the bottom surface 14a of the ring groove 14 and the pair of side surfaces 14b, 14c of the ring groove 14 (see FIG. 1).

When the compressor operates, making the internal pressure of the housing higher than the external pressure thereof, the differential pressure between the inside and outside of the housing acts on the O ring 3. In this embodiment, however, at the time when the first housing member 1 and the second housing member 2 are joined together, the O ring 3 is already in contact with the pair of side surfaces 14b, 14c, especially, the one side surface (side surface close to the outer wall surface of the housing) 14b of the ring groove 14. Therefore, the O ring 3 does not move inside the ring groove 14 but just deforms due to the pressure difference. This makes it possible to prevent a twist in the O ring 3 and resultant reduction in sealing property and in turn, to ensure stable sealing property throughout the O ring 3 in the circumferential direction.

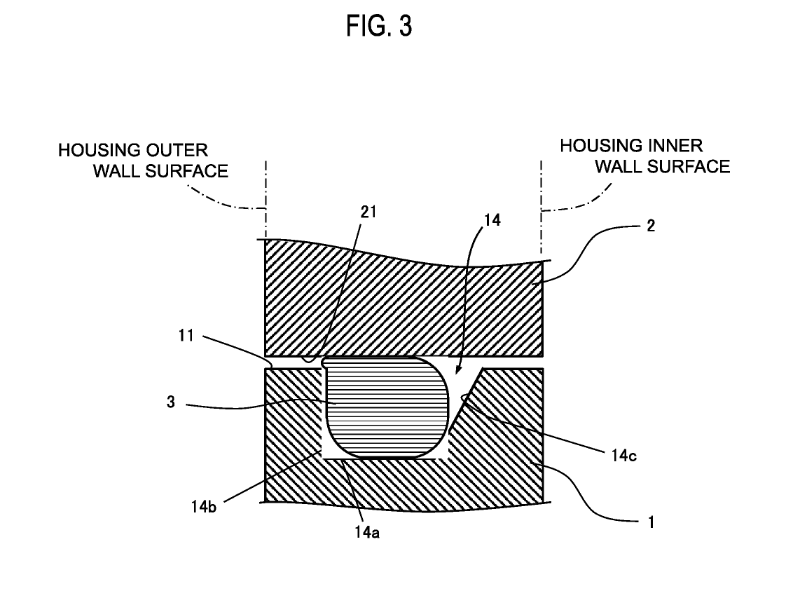

Also, since the O ring 3 does not move as mentioned above, the pressure difference is utilized for deformation of the O ring 3. Consequently, the O ring 3 comes into closer contact with the one side surface 14b of the ring groove 14 than in conventional ones and also, the O ring 3 largely deforms toward a gap between the end surface 11 of the first housing member 1 and the end surface 21 of the second housing member 2 on the outer wall surface side of the housing or largely deforms to get into the gap, compared with conventional ones (see FIG. 3). Hence, the sealing property is significantly improved, compared with conventional ones.

Moreover, since the width W2 of the opening edge of the ring groove 14 is larger than the wire diameter d0 of the uncompressed O ring 3, there is no fear of lowering workability at the time of inserting the O ring 3 into the ring groove 14

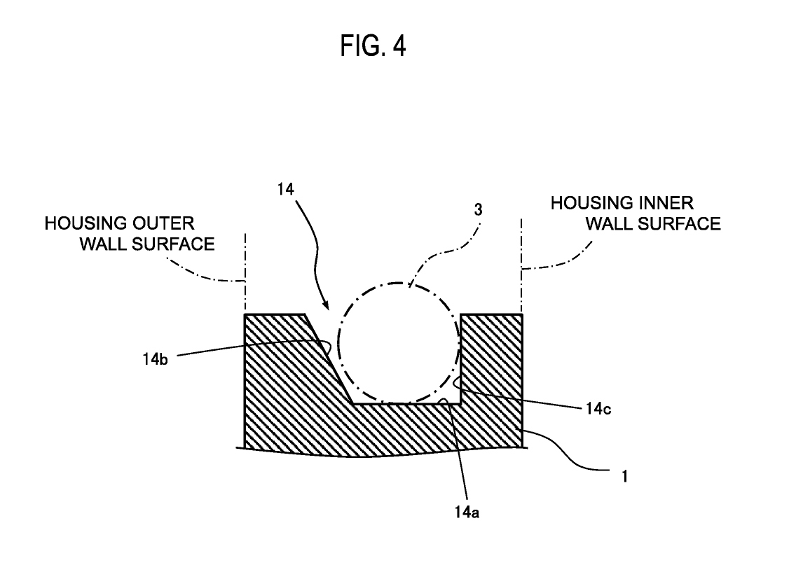

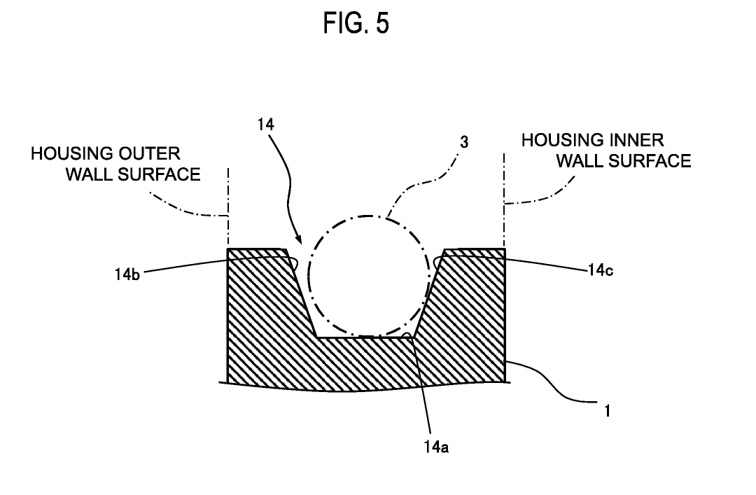

Note that in the above embodiment, the side surface 14b close to the outer wall surface of the housing out of the pair of side surfaces 14b, 14c of the ring groove 14 is formed as the perpendicular surface and the side surface 14c close to the inner wall surface of the housing is formed as the inclined surface. However, the present invention is not limited to these examples. For example, the structure shown in FIG. 4 is conceivable. The structure is opposite to the above embodiment in that the side surface 14b close to the outer wall surface of the housing is formed as an inclined surface, and the side surface 14c close to the inner wall surface of the housing is formed as a perpendicular surface. In this case, the O ring 3 deforms along the inclined surface due to the pressure difference. The O ring 3 is expected to more largely deform toward the gap or deform to get into the gap and in turn, to improve the sealing property. Also, as shown in FIG. 5, both the pair of side surfaces 14b, 14c of the ring groove 14 can be formed as the inclined surface. Here, it is preferred, as in the above embodiment or the embodiment shown in FIG. 4, that either one of the side surfaces be formed as the perpendicular surface.

Also, in the above embodiments, the ring groove 14 is formed such that the O ring 3 can be inserted thereinto in contact with the bottom surface 14a and the other side surface (inclined surface) 14c of the ring groove 14. However, the present invention is not limited thereto. The ring groove 14 can be formed so that the O ring 3 is inserted thereinto in contact with the bottom surface 14a and the one side surface (perpendicular surface) 14b of the ring groove 14. To be specific, the ring groove 14 has only to be formed so that the O ring 3, compressed by joining the first housing member 1 and the second housing member 2 together, comes into contact with the bottom surface 14a and the pair of side surfaces 14b, 14c of the ring groove 14.

Furthermore, the ring groove 14 may be formed so that the inserted O ring 3 comes into contact with the bottom surface 14a and the pair of side surfaces 14b, 14c of the ring groove 14. In this case, the width W1 of the bottom surface 14a of the ring groove 14 can be smaller than the wire diameter d0 of the uncompressed O ring 3 (the same applies to the structure of FIGS. 3 and 4). According to this structure, the O ring 3 can come into closer contact with the one side surface 14b due to the pressure difference and also, the O ring 3 more largely deforms toward the gap or deforms to get into the gap, hereby further improving the sealing property. Note that this structure has a possibility of lowering the workability at the time of inserting the O ring 3 into the ring groove 14 compared with the above embodiments.

The preferred embodiments of the present invention are described so far, but the present invention is not limited to these embodiments and various modifications and changes can be made based on the technical ideas of the present invention.

### REFERENCE SYMBOL LIST

1 First housing member
2 Second housing member
3 O ring
11 End surface of first housing member
14 Ring groove
14a Bottom surface of ring groove
14b Side surface of ring groove (side surface close to outer wall surface of housing)
14c Side surface of ring groove (side surface close to inner wall surface of housing)
21 End surface of second housing member

1. A sealing structure for a housing join of a fluid machine, which is used to seal a join between first and second housing members constituting a housing of the fluid machine, the sealing structure comprising:
a ring groove formed in an end surface of the first housing member; and
an O ring to be inserted into the ring groove,
wherein the ring groove has an inverted trapezoid shape in cross section, of which a width of an opening edge is larger than a width of a bottom surface,
when the first and second housing members are joined together, the inserted O ring is compressed between the bottom surface and an end surface of the second housing member and the compressed O ring comes into contact with the bottom surface and both of a pair of side surfaces extending upward from the bottom surface at its opposite ends in a width direction,
one side surface of the pair of side surfaces of the ring groove is formed as a perpendicular surface at right angle to the bottom surface and the other side surface of the pair of side surfaces of the ring groove is formed as an inclined surface that gradually increases a distance from the perpendicular surface in a direction from the bottom surface to the opening edge, and
the one side surface formed as the perpendicular surface is positioned close to an outer wall surface of the housing, and the other side surface formed as the inclined surface is positioned close to an inner wall surface of the housing, at which a pressure becomes higher than at the outer wall surface during operation of the fluid machine.

2. The sealing structure for a housing join of a fluid machine according to claim 1, wherein the ring groove is formed such that before the first and second housing members are joined together, the inserted O ring comes into contact with the bottom surface and one of the pair of side surfaces and also, an upper portion of the inserted O ring protrudes from the opening edge.

3. The sealing structure for a housing join of a fluid machine according to claim 1, wherein a depth of the ring groove is smaller than the uncompressed O ring, and the width of the opening edge of the ring groove is larger than a wire diameter of the uncompressed O ring.

4. The sealing structure for a housing join of a fluid machine according to claim 3, wherein the width of the bottom surface of the ring groove is smaller than the wire diameter, in the width direction of the bottom surface of the ring groove, of the O ring compressed between the bottom surface of the ring groove and the end surface of the second housing member.

5. The sealing structure for a housing join of a fluid machine according to claim 3, wherein the width of the bottom surface of the ring groove is smaller than the wire diameter of the uncompressed O ring.

6-8. (canceled)
